(19) United States
(12) Patent Application Publication
(10) Pub. No.: US 2025/0147165 A1
(43) Pub. Date: May 8, 2025

(54) METHOD AND SYSTEM FOR DETECTING A SEAT OCCUPANCY STATE OF A SEATING ARRANGEMENT ON THE BASIS OF RADAR POINT CLOUDS

(71) Applicant: GESTIGON GMBH, Luebeck (DE)

(72) Inventors: Verena Krueckemeier, Luebeck (DE); Lena Werner, Luebeck (DE); Alexander Vanaev, Bietigheim-Bissingen (DE); Joshua Schwab, Bietigheim-Bissingen (DE)

(73) Assignee: GESTIGON GMBH, Luebeck (DE)

(21) Appl. No.: 18/837,888

(22) PCT Filed: Feb. 13, 2023
(86) PCT No.: PCT/EP2023/053411

§ 371 Date: Aug. 13, 2024

(30) Foreign Application Priority Data
Feb. 17, 2022 (DE) 10 2022 103 818.1

(51) Int. Cl. G01S 13/04; G01S 13/89; G06V 10/762; G06V 20/59

(52) U.S. Cl. CPC G01S 13/04; G01S 13/89; G06V 10/762; G06V 20/593

(57) ABSTRACT

A method for the automated detection of a seat occupancy state, in particular related to each seat, of a seating arrangement having at least one seat comprises: receiving or generating measurement data, which represents in each case one assigned radar point cloud for each measurement frame of a sequence of a plurality of temporally consecutive measurement frames, so that the measurement data represent a sequence of radar point clouds corresponding to the sequence of measurement frames, wherein each radar point cloud of the sequence was or is obtained on the basis of a radar scan of a spatial region surrounding at least some sections of the seating arrangement, which takes place at a measurement time or during a measurement period assigned to the respective measurement frame; accumulating a plurality of the radar point clouds of the sequence in order to obtain an accumulated radar point cloud containing radar points from each of the individual radar point clouds combined as part of the accumulating process; determining a seat occupancy state of the seating arrangement on the basis of an evaluation model, which returns, as a function of the accumulated radar point cloud, one of a plurality of predefined possible seat occupancy states of the seating arrangement as an evaluation result; and outputting a piece of information defined according to the evaluation result.

The present invention relates to a method, a computer program and a system configured for carrying out the method, in each case for automatically detecting a seat occupancy state of a seating arrangement having at least one seat.

In various situations, it may be necessary to automatically determine the current seat occupancy state of a seating arrangement having at least one seat. Such a situation may occur in particular in vehicles, for example in motor vehicles, where a configuration of the vehicle or an activation, deactivation and/or control of one or more vehicle functionalities is to be carried out depending on a current seat occupancy state. For example, in motor vehicles, it is known to output an acoustic or visual warning to vehicle occupants to apply seatbelts or to control the activation or deactivation of airbags depending on a detected seat occupancy state.

For the automated detection of a current seat occupancy state of one or more seats, in particular an arrangement of vehicle seats in a vehicle, so-called seat occupancy mats are known for this purpose, which are integrated into the seats (usually one per seat) and use pressure-sensitive sensors for detecting whether the respective seat is occupied. A seat occupancy state of the seat is determined depending on the sensor signals or sensor data of these sensors, usually by means of a threshold comparison.

These known solutions therefore require the seats to be equipped with built-in sensors and are usually also unable to distinguish between different seat occupancy states other than “occupied” and “unoccupied”. In addition, the sensors typically have to be integrated into the seats at the factory, making retrofitting difficult or impossible and eliminating the ability to detect a seat occupancy state of seats not equipped in this way.

It is an object of the present invention to provide an improved solution for the automated detection of a seat occupancy state of a seating arrangement having at least one seat.

The object is achieved according to the teaching of the independent claims. Various embodiments and developments of the invention are the subject matter of the dependent claims.

A first aspect of the solution presented here relates to an in particular computer-implemented method for the automated detection of a seat occupancy state, in particular based on individual seats, of a seating arrangement having at least one seating position (or equivalent: seat), in particular seats in or for a vehicle, such as an automobile (e.g. lorry, car or bus). The method comprises: (i) receiving or generating measurement data representing an assigned radar point cloud for each measurement frame of a sequence of a plurality of temporally consecutive measurement frames, so that the measurement data represents a sequence of radar point clouds corresponding to the sequence of the measurement frames. Each radar point cloud of the sequence was or is obtained on the basis of a radar scan of a spatial region surrounding at least some sections of the seating arrangement, which takes place at a measurement time or during a measurement period assigned to the respective measurement frame; (ii) accumulating a plurality of the radar point clouds of the sequence in order to obtain an accumulated radar point cloud containing radar points, in particular all radar points, from each of the individual radar point clouds combined as part of the accumulating process; (iii) determining, in particular estimating, a seat occupancy state of the seating arrangement on the basis of an evaluation model, which returns, as a function of the accumulated radar cloud, one of a plurality of predefined possible seat occupancy states of the seating arrangement as an evaluation result; and (iv) outputting a piece of information defined according to the evaluation result.

The term “seat occupancy state” of a seating arrangement with at least one seat, as used herein, is to be understood in particular to mean information indicating whether or to what extent the seating arrangement or at least one of its seats is occupied or taken up by an object, in particular a person or thing. The seat occupancy state in a simple example may only indicate the presence or absence of an object, or in a further developed example, in the case of the presence of at least one object on the seating arrangement or one or more of its seats, make a statement about the nature or another characteristic of the object, for example, its spatial extent.

The term “radar point cloud”, as used herein, is to be understood in particular to mean a set of points of a vector space obtained by means of radar scanning of at least one object surface, which has a typically unorganized spatial structure (“cloud”). In the case of a radar point cloud, the points of the radar point cloud can be called “radar points”. A (radar) point cloud can be described in particular by the (radar) points contained in it. The radar points, in turn, can each be described in particular by their spatial coordinates, each of these radar points specifying a location of reflection of a radiated radar signal at an object surface measured in the radar scanning. In addition to the radar points, attributes such as measured Doppler velocity or a signal-to-noise ratio (SNR) can be acquired.

The term “accumulated radar point cloud”, as used herein, is to be understood to mean a radar point cloud which results from the accumulation of a plurality of individual radar point clouds—in particular in the mathematical sense of a set union—so that the accumulated radar point cloud contains radar points, in particular all radar points, from each of the individual radar point clouds combined as part of the accumulation. In particular, an accumulated radar point cloud may contain more radar points than each of the individual radar point clouds included in the accumulation. The term “accumulate” should therefore be understood to mean such a grouping of a plurality of individual radar point clouds to form an accumulated radar point cloud.

The term “measurement frame”, as used herein, is understood in particular to mean a measurement time or a measurement period in a chronological sequence of defined, in particular periodically, consecutive measurement points or measurement periods, at or during which each measurement, in the present case a radar scan of at least one object surface, takes place or has taken place. Each measurement frame is assigned the result of the measurement associated with it, in this case the radar point cloud generated for the measurement frame by radar scanning.

The term “evaluation model”, as used herein, is understood to mean an in particular mathematical model which an, in particular accumulated, radar point cloud, or one or more parameters characteristic of it, uses as input variable(s) to return an evaluation result dependent on it, in the present case one of multiple predefined possible seat occupancy states of the seating arrangement. In particular, the evaluation model may be a mathematical estimation function, wherein the accumulated radar point cloud represents empirical data as a random sample and the evaluation result represents an estimation determined as a function of it. The evaluation model may in particular be a “machine learning model”, which is understood here in particular to mean a mathematical, in particular statistical, model for making predictions or decisions by means of at least one machine learning algorithm on the basis of example data, known as training data, without the algorithm(s) being explicitly programmed to make such predictions or decisions. In particular, decision tree-based models for machine learning are machine learning models.

In particular, the information to be output can represent the evaluation result itself. It may also be a signal, in particular detectable with a human sense, such as a warning, or a control signal for activating a signal source, or a data signal carrying the information.

The terms “comprises,” “contains,” “includes,” “has,”, “having” or any other variant thereof as may be used herein are intended to cover non-exclusive inclusion. By way of example, a method or a device that comprises or has a list of elements is thus not necessarily limited to those elements, but may include other elements that are not expressly listed or that are inherent in such a method or such a device.

Furthermore, unless expressly stated otherwise, “or” refers to an inclusive or and not to an exclusive “or”. For example, a condition A or B is satisfied by one of the following conditions: A is true (or present) and B is false (or absent), A is false (or absent) and B is true (or present), and both A and B are true (or present).

The terms “a” or “an” as used herein are defined as “one or more”. The terms “another” and “a further” and any other variant thereof should be understood in the sense of “at least one other”.

The term “plurality” as used here should be understood in the sense of “two or more”.

The terms “configured” or “designed” to fulfil a particular function (and any variations thereof) as may be used herein are understood to mean for the purposes of the invention that the corresponding device is already present in a configuration or setting in which it can perform the function or the device is at least adjustable—i.e. configurable—such that it can perform the function after appropriate adjustment. The configuration can be applied, for example, by an appropriate setting of parameters of a process sequence or of switches or similar for activating or deactivating functionalities or settings. In particular, the device may comprise multiple predetermined configurations or operating modes, so that the configuration can be carried out by means of a selection of one of these configurations or operating modes.

Using the method according to the first aspect, an evaluation result characterizing (in particular in the sense of a prediction or classification) a seat occupancy state of the seating arrangement can be obtained on the basis of radar point clouds collected from a temporal sequence of an actual or simulated radar scan of a spatial region surrounding the seating arrangement. Thus, radar-based solutions can be implemented, in particular in the vehicle context (in particular for automobiles), which can reliably detect a seat occupancy state (in particular exclusively) by means of radar and, on this basis, can activate, deactivate or control certain functionalities or systems, such as a seatbelt warning system or an airbag system, either altogether or selectively.

The number of radar points generated per radar point cloud in many radar measurement techniques depends on whether or in what manner an object is moving. The use of at least one accumulated radar point cloud compressed by accumulation of a plurality of temporally consecutive radar point clouds serves in particular to increase the number of radar points on the basis of which the evaluation for determining the seat occupancy state is carried out. The quality of the evaluation can be increased, in particular the error rate can be reduced. This is particularly important if the individual radar point clouds obtained for the individual measurement frames only have a small number of radar points in each case (known as a “sparse point cloud”), so that without accumulation, the evaluation could become inaccurate or prone to errors due to an insufficient database. This can be the case in particular in the case of stationary or only slightly moving objects, e.g. when a stationary item, a person moving very little or a very small object is on a seat.

Various exemplary embodiments of the method will now be described below, each of which, unless expressly excluded or technically impossible, may be combined as desired with one another and with the other aspects of the present solution also described.

In some embodiments the accumulation of the plurality of radar point clouds of the sequence is carried out multiple times in order to obtain an accumulated radar point cloud, which contains radar points, in particular all radar points, from each of the individual radar point clouds combined as part of the respective accumulation, wherein during each accumulation, only radar point clouds of an individual subset of the sequence assigned thereto are accumulated, so that at least two of the subsets are different. The seat occupancy state of the seating arrangement is determined as a function of at least two of the accumulated radar point clouds. In this way, in particular, a time curve of the radar scan can be used to determine the seat occupancy state of the seating arrangement. On the basis of such a time curve, in particular a movement or a certain movement pattern of one or more objects on the seating arrangement and thus the presence of the object or objects themselves can be detected with higher reliability than would be typically possible on the basis of a single accumulated radar point cloud. This further increases the quality and reliability for the automated detection of a seat occupancy state of the seating arrangement.

In some embodiments, the method further comprises: for each of the at least two accumulated radar point clouds taken into account in determining the seat occupancy state, determining the respective value of at least one defined characteristic value for characterizing radar point clouds. The evaluation model is or will be defined in such a way that, when determining the seat occupancy state of the seating arrangement, the evaluation result is determined as a function of the respective values of the at least one characteristic value for the at least two accumulated radar point clouds that are taken into account in determining the seat occupancy state. In this way, the evaluation model can be defined and applied in a simplified manner, since instead of entire accumulated radar point clouds, only the values of the at least one characteristic value need be taken into account as input variables. In particular, the time curve of the values can reflect a movement or a specific movement pattern of one or more objects on the seating arrangement, so that the evaluation model can determine the seating occupancy state of the seating arrangement in a particularly reliable manner on this basis.

In particular, in some embodiments the subsets are selected on a rolling basis in order to form an ordered series of subsets, in such a way that a first of the subsets has a number N of consecutive point sets in the sequence, and each subsequent further subset emerges from the respective preceding subset by replacing the leading point sets of the preceding subset, in accordance with their order in the sequence M, in the following subset by the next M point sets in the sequence, where 0<M<N with N, M ∈ N applies. This allows smoothing of the input variable(s) provided to the evaluation model, which in turn can be used to increase quality.

In particular, it has been found that the following value ranges are favorable in ensuring a high quality of the method: N is or will be selected such that 4<N<8; and/or M is or will be selected such that M=1 or M=2.

A particularly suitable selection is N=6 and M=1. In this case, the respective radar point clouds of N=6 temporally consecutive frames each are combined to form a subset or an accumulated radar point cloud based thereon. If, for example, the measurement frames are sequentially numbered 1, 2, 3, etc. according to their chronological order, then a first accumulated radar point cloud can be generated by accumulating the individual radar point clouds of the measurement frames 1 to 6. The subsequent, second accumulated radar point cloud can then be generated by accumulating the individual radar point clouds of the measurement frames 2 to 7, etc. In this rolling process, the leading measurement frame of the preceding subset is thus no longer included in the immediately following subset, but is replaced by the next measurement frame that follows it. Overall, this results in a temporal sequence of accumulated radar point clouds, each of which is defined by the accumulation of N individual radar point clouds. Thus, a time curve of successive accumulated radar point clouds can be generated, again with the aforementioned advantages.

In some embodiments, when determining the seat occupancy state of the seating arrangement, the evaluation result is determined as a function of the series of the respective values of the characteristic value for the subsets of the series corresponding to the series of subsets, for each characteristic value. This again reduces the complexity of the input variable(s) for the evaluation model. In particular, computational effort can be saved and high performance, in particular real-time capability, can be achieved with less powerful computing resources or fewer computing resources.

In some embodiments, the series of their respective values is analyzed for at least one of the characteristic values to determine whether a periodic curve, in particular a curve corresponding to a periodic breathing pattern, of the characteristic value is detected therein. The evaluation result is then determined according to the result of the analysis. In particular, not only can the presence of any object on a seat of the seating arrangement be detected, but even with high reliability a distinction can be made between living objects present on the seating arrangement, especially between persons and mammals such as pets (e.g. dogs). In particular, it is possible to display the information to be output in accordance with the method depending on the detection or non-detection of such a periodic curve. In particular, one or more detected frequencies of the periodic curve can be taken into account, in particular in such a way that the information is defined as a function of whether the or a frequency is within a certain frequency range such as a typical respiratory frequency range. In particular, a seatbelt fastening warning function or an airbag system can be controlled depending on whether a respiratory rate, and thus with a high probability a person, was detected on the seating arrangement or a specific seat of it.

In some embodiments, the or one of the characteristic values is or will be defined by the number of radar points in the respective accumulated radar point cloud or a quantity dependent on that number. If in the radar scanning in a measurement frame the number of radar points of the radar point cloud generated depends on the extent to which the scanned object is moving, the extent of the movement can thus be represented in the characteristic value(s), in particular with regard to the aforementioned detection of a respiratory frequency of the object.

In some embodiments, the sequence of measurement frames is or will be defined such that the temporally consecutive measurement frames follow one another periodically with a frequency f, where 6 fps≤f≤9 fps. In particular a frequency f where 7 fps≤f≤8 fps has been shown to be advantageous (fps=frames per second, i.e. measurement frames per second).

In some embodiments, the evaluation model comprises a trained machine learning model. Data which at least represents an accumulated radar point cloud or values of one or more characteristic values defined for them, is provided as input data to the machine learning model in order to obtain the evaluation result as its output. This allows a particularly flexible and adaptable implementation of the evaluation model, wherein machine learning can be used to continuously improve the evaluation model and thus the quality and reliability of the seat occupancy recognition. In particular, the evaluation result can indicate a class of a seat occupancy state classification. In particular, the machine learning model may be a decision tree-based model or a model based on an artificial neural network.

In some embodiments (“first group”), the seating arrangement comprises a plurality of seats for which a seating situation state is to be determined individually or cumulatively as part of the method. For each (individual) radar point cloud, the set of its radar points is sub-divided by means of clustering, as a function of the respective spatial position of the radar points in relation to the seats, into a plurality of clusters each containing a subset of the radar points in order to individually assign to each of the seats one of the clusters located spatially closest to it. (The clustering thus already takes place at the level of the individual radar point cloud(s)). The accumulation of radar point clouds of the sequence is carried out in clusters, wherein for each cluster, only the radar points belonging to said cluster of the respective radar point clouds to be accumulated are accumulated, in order to form a respective accumulated radar point cloud for each cluster. The determination of the seat occupancy state of the seating arrangement comprises an individual determination of a respective individual seat occupancy state for each of the seats as a function of the accumulated radar point cloud determined for the respective associated cluster, in order to obtain an evaluation result, in particular classification result, characterizing a seat occupancy state of the respective seat. The information to be output is then defined according to the respective individual evaluation results for the different seats.

In some embodiments of the first group, each radar point cloud is segmented into a plurality of clusters by each of the seats being assigned as a cluster a subset of the radar points of the respective radar point cloud according to their respective position, such that the radar points of the cluster are located in a defined closed spatial region, in particular a cuboid, in the vicinity of the seat. This enables a particularly simple and less computationally intensive clustering and thus seat-related seat occupancy detection, wherein the location (position and orientation) and the shape of the spatial region is or can be defined in such a way that it will usually strongly overlap the spatial region occupied by a typical object to be detected, in particular a person, on a seat of the seating arrangement.

In some other embodiments (“second group”), the seating arrangement also comprises a plurality of seats for which a seating situation state is to be determined individually or cumulatively as part of the method. Here, however, for each accumulated radar point cloud, the set of its respective radar points is sub-divided by means of clustering, as a function of the respective spatial position of the radar points in relation to the seats, into a plurality of clusters each containing a subset of the radar points in order to individually assign to each of the seats one of the clusters located spatially closest to it. (The clustering here thus takes place at the level of the previously accumulated individual radar point cloud(s)). The determination of the seat occupancy state of the seating arrangement comprises an individual determination of a respective individual seat occupancy state for each of the seats as a function of the accumulated radar point cloud determined for the respective associated cluster, in order to obtain an evaluation result characterizing a seat occupancy state of the respective seat. The information to be output is defined according to the respective individual evaluation results for the different seats.

The embodiments of the second group thus represent alternatives to the embodiments of the first group. In both cases, in the case of a multi-seat seating arrangement, a seat-related, i.e. individually per seat, seat occupancy detection is made possible, which is particularly advantageous or even necessary when a seat-related response to the detected seat occupancy is to be made, for example, by activating or deactivating or otherwise controlling a specific functionality or system, such as a seat-related airbag system, a seat-related seat belt warning or a seat-related seat heater, for a specific seat depending on the seat occupancy detected.

In some embodiments of the second group, each accumulated radar point cloud is segmented into a plurality of clusters by each of the seats being assigned as a cluster a subset of the radar points of the respective accumulated radar point cloud according to their respective position, such that the radar points of the cluster are located in a defined closed spatial region, in particular a cuboid, in the vicinity of the seat. This enables a simplified and less computationally intensive clustering and thus seat-related seat occupancy detection, even compared to the first group, wherein the location (position and orientation) and the shape of the spatial region is or can be defined in such a way that it will usually strongly overlap the spatial region occupied by a typical object to be detected, in particular a person, on a seat of the seating arrangement.

The clusters thus each contain an, in particular true, subset of the set of radar points of the respective total (for the first group) individual or (for the second group) accumulated radar point cloud. In some embodiments, the clustering can be carried out in particular such that the clusters are disjoint, so that no radar point is assigned to two different clusters.

In some embodiment, the or each individual or accumulated radar point cloud is segmented into multiple clusters by assigning a subset of the radar points as a cluster to each of the seats depending on their respective position, in particular uniquely per radar point, such that the radar points of the cluster are located in a defined closed, in particular cuboid, spatial region in the vicinity of the seat. In particular, the assignment can be carried out in such a way that each radar point is assigned to the cluster of the seat located nearest to it. Thus, the radar point cloud can be divided into clusters, i.e. subsets of the radar point cloud localized in the vicinity of the respective seats, so that the seat-specific seat occupancy states can be determined in a targeted manner and therefore with high reliability on the basis of the cluster assigned to the respective seat.

In some embodiments, the output of the information comprises activating a signal source as a function of the information to cause the signal source to output a defined signal depending on the activation. The signal source may in particular be an audio source, an optical signal source, in particular a display device for images or text, and/or a haptic actuator or a combination of at least two of the aforementioned signal sources. This means that by means of the signaling, the detected seat occupancy state can be communicated to a user or used to control another technical system, such as an airbag system.

In some of these embodiments the signal source is activated as a function of the information so as output a signal, in particular defined by the activation, if the information results from an evaluation result, according to which at least one seat of the seating arrangement is occupied and/or a selected predefined seat occupancy state is present.

In some embodiments, the method further includes: (i) detecting a seatbelt fastening state of at least one seat in the seating arrangement or receiving seatbelt information identifying this seatbelt fastening state; (ii) wherein the signal source is activated as a function of the seatbelt information and the information from the evaluation result in such a way as to output a seatbelt fastening warning signal if, according to the information, at least one seat of the seating arrangement is occupied and/or a selected predefined seat occupancy state is present and seatbelt information indicates that the associated seatbelt is not fastened. In this way, radar-based seatbelt checking and warning systems can be achieved, in particular with regard to the detection only.

In some embodiments, the individual radar points of the radar point cloud are represented by a position of the respective radar point in three-dimensional space and by at least one of the following parameters: (i) a Doppler-shift value of the radar signal at the relevant radar point; (iii) a signal-to-noise ratio value of the radar signal at the relevant radar point. These parameters can be used in particular for pre-filtering the radar point cloud as part of a pre-processing stage prior to the feature extraction.

In particular, in some of these embodiments, the determination of the seat occupancy state of the seating arrangement on the basis of the evaluation model is carried out exclusively, or at least predominantly in a numerical sense, on the basis of those radar points for which the Doppler-shift value is at or above a predefined non-zero shift threshold. Thus, only or at least predominantly so-called dynamic radar points are used as the basis for the evaluation, i.e. such radar points as indicate a movement of the scanned object, the Doppler-shift value of which is at or above the shift threshold. This can be used in particular to further increase the quality, in particular the reliability of the method, because static, i.e. essentially stationary points on the object surfaces, such as points on a seat surface of a seat, are not included in the evaluation, or only in smaller numbers than points that display dynamics and are therefore highly likely to be assigned to a living being, in particular a person or an animal. This allows the output information obtained from the evaluation (e.g. for airbag control or a seatbelt warning system) to be utilized, in particular, according to whether a living being or a static object surface has been detected.

A second aspect of the present solution relates to a system, in particular a data processing device, for the automated detection of an, in particular any, seat occupancy state of a seating arrangement having at least one seat, in particular with at least one vehicle seat in or for a vehicle. In this case, the system comprises a data processing device which is configured, in particular by means of a corresponding computer program, to carry out the method according to the first aspect to detect the seat occupancy state.

A third aspect of the present solution relates to a computer program or computer program product, comprising instructions which, when executed on the data processing device of the system according to the second aspect, cause the system to execute the method according to the first aspect.

The computer program can, in particular, be stored in a non-volatile data carrier. This is preferably a data carrier in the form of an optical data carrier or a flash memory module. This may be advantageous if the computer program as such is to be handled independently of a processor platform on which the one or more programs are to be run. In another implementation, the computer program can be present as a file on a data processing unit, in particular on a server, and can be downloaded via a data link, for example the Internet or a dedicated data link such as a proprietary or local network. In addition, the computer program can have a multiplicity of individual interacting program modules. In particular, the modules can be configured to be used, or in any case can be used, in such a way that they can be used in the sense of distributed computing on different devices (computers or processor units) that are geographically remote and connected to each other via a data network.

The system according to the second aspect can correspondingly have a program memory in which the computer program is stored. Alternatively, the system can also be configured to access, via a communication link, a computer program which is available externally, for example on one or more servers or other data processing units, in particular in order to exchange therewith data which is used while the method or computer program is running, or constitutes outputs of the computer program.

A fourth aspect of the present solution relates to a vehicle comprising: (i) a seating arrangement having at least one seat; (ii) a radar sensor for radar scanning at least sections of the seating arrangement; and (iii) a system according to the second aspect for the automated detection of an, in particular respective, seat occupancy state of the seating arrangement as a function of a radar scan of at least sections of the seating arrangement carried out by the radar sensor.

The features and advantages which are explained with respect to the first aspect of the present solution apply correspondingly also to the further aspects of the invention.

Further advantages, features and application possibilities of the present solution can be found in the following detailed description in conjunction with the figures.

In the drawings:

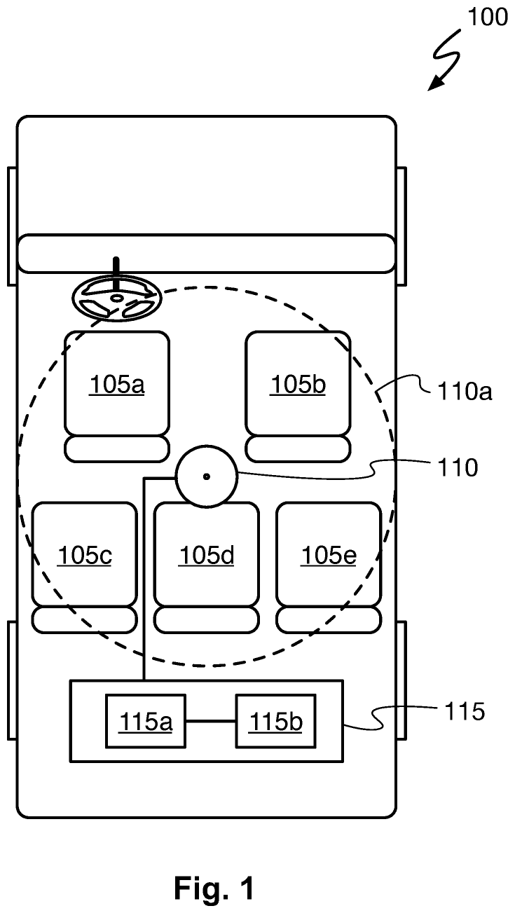

FIG. 1 shows schematically an exemplary embodiment of a vehicle, which is equipped with a system for the automated detection of a seat occupancy state of a seating arrangement in the vehicle;

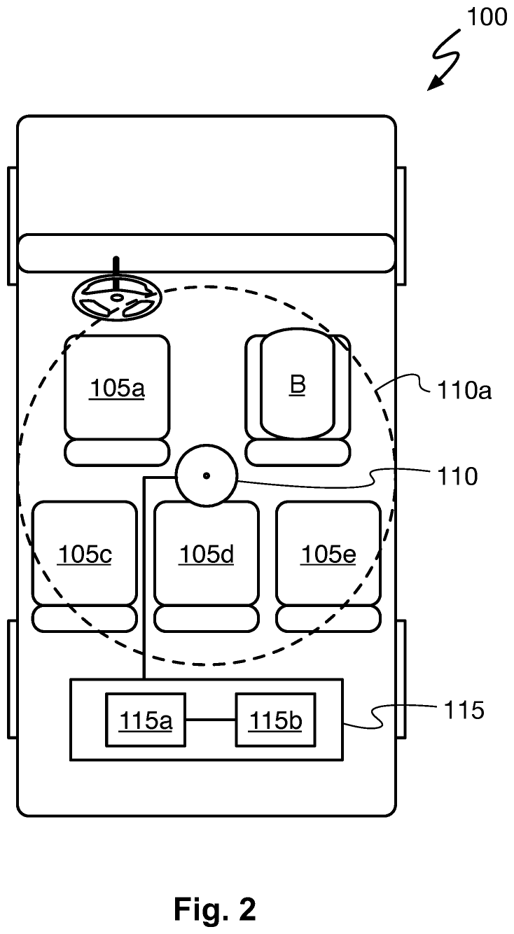

FIG. 2 shows schematically the vehicle from FIG. 1, wherein here on the front passenger seat a baby seat with a baby lying therein is present as an object to be detected;

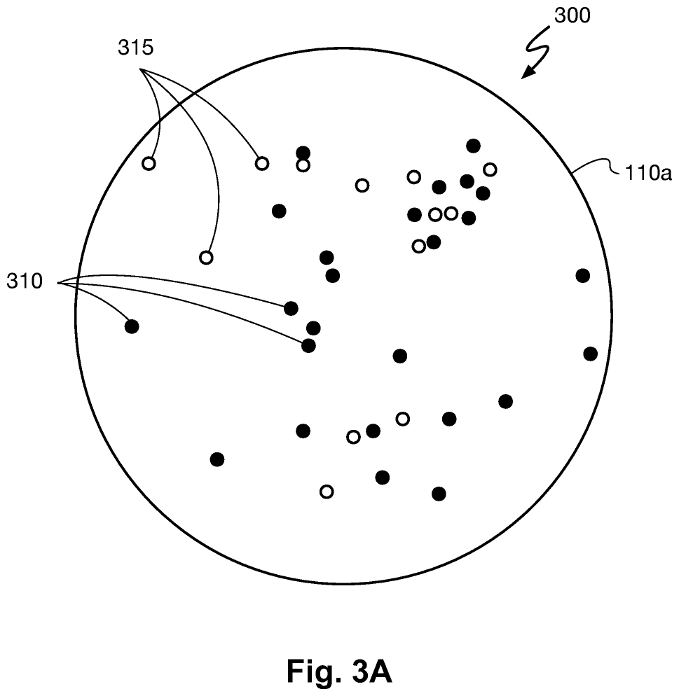

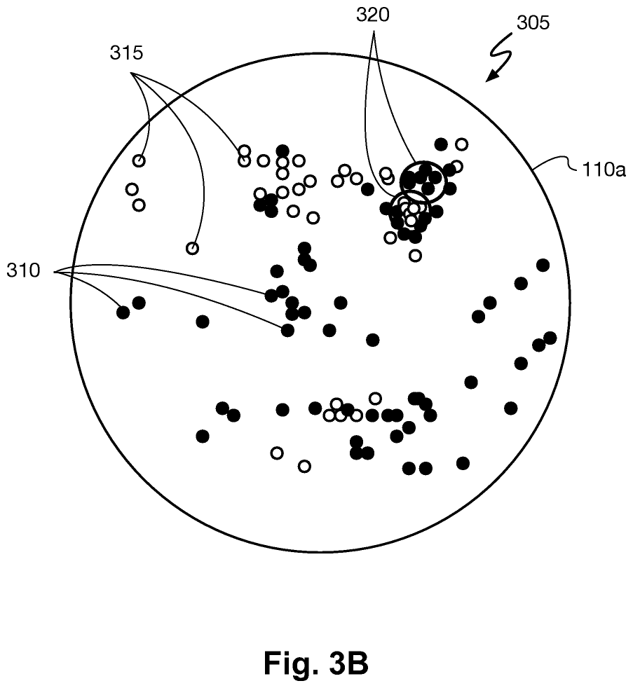

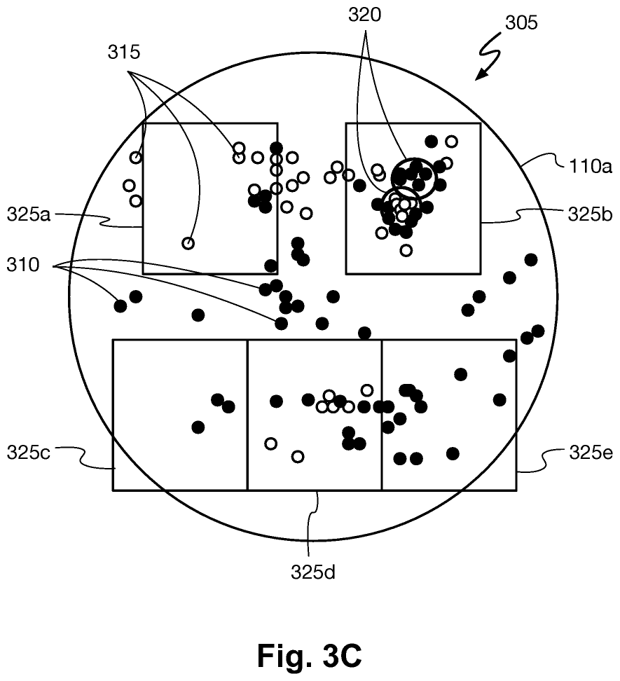

FIG. 3A shows an exemplary two-dimensional representation of a (single) radar point cloud corresponding to a single measurement frame captured by a radar sensor of the vehicle from FIG. 2;

FIG. 3B shows an exemplary two-dimensional representation of an accumulated radar point cloud, which has been produced by accumulation from the respective individual radar point clouds of multiple successive measurement frames recorded according to FIG. 3A;

FIG. 3C shows an exemplary representation of a clustering of the accumulated radar point cloud of the embodiment in 3B according to the positions of the individual seats in the seating arrangement;

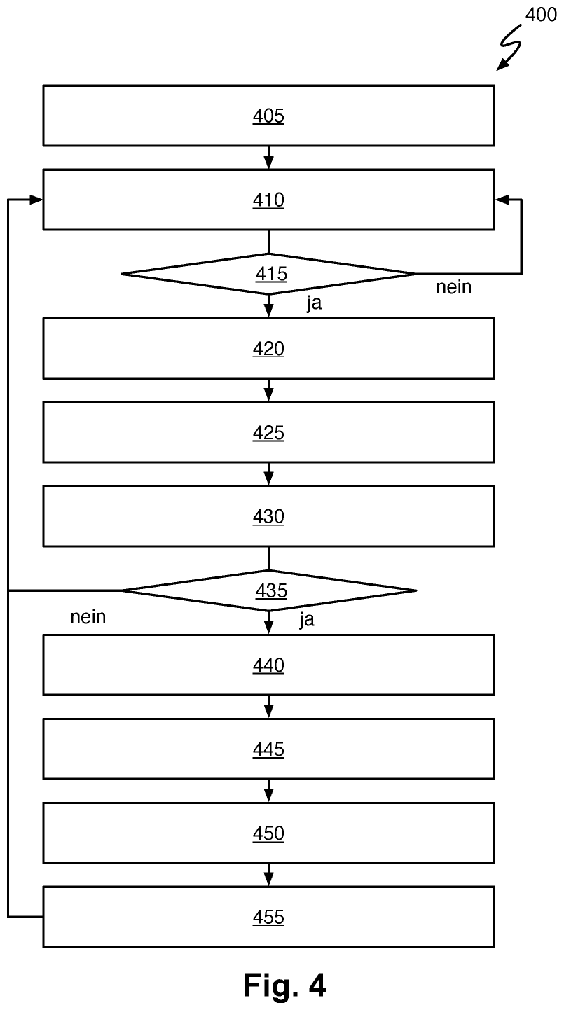

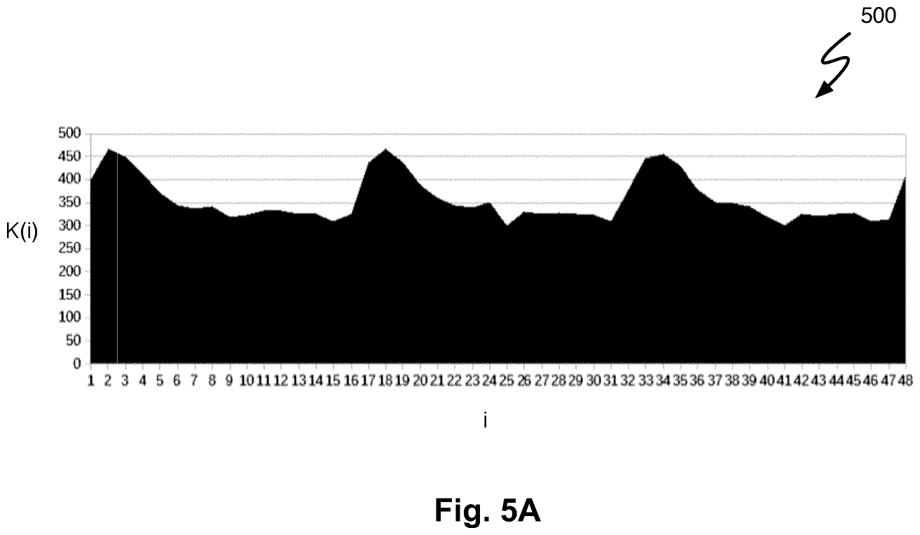

FIG. 4 shows a flow diagram illustrating an exemplary embodiment of a method for automatically detecting a seat occupancy state of a seating arrangement;

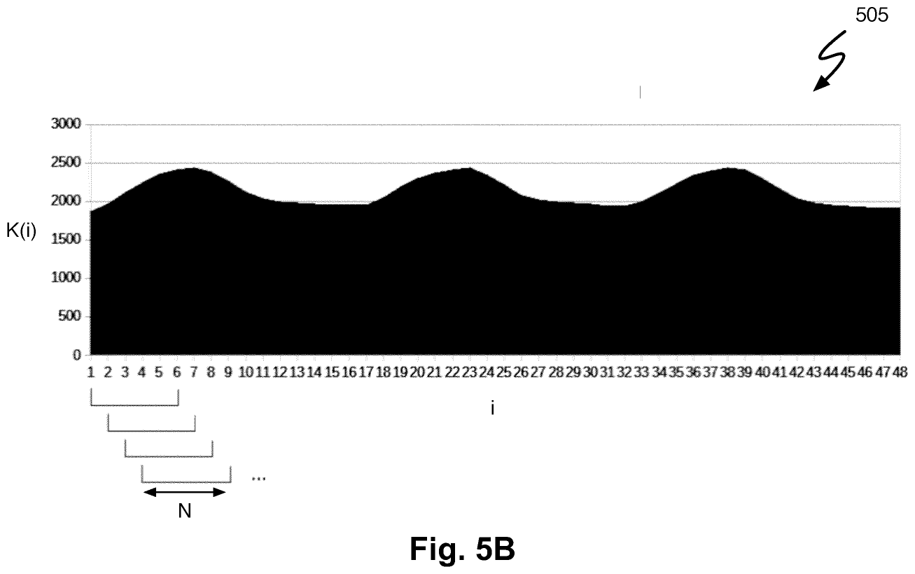

FIG. 5A shows an exemplary representation of the curve of the value of a characteristic value for individual radar point clouds for a sequence of measurement frames; and

FIG. 5B shows an exemplary representation of the curve of the value of a characteristic value for already accumulated radar point clouds for the same sequence of measurement frames as in FIG. 5A.

In the figures, identical reference signs designate identical, similar or mutually corresponding elements. Elements in the figures shown are not necessarily shown to scale. Rather, the different elements shown in the figures are reproduced in such a way that their function and general purpose are understandable to the person skilled in the art. Connections and couplings between functional units and elements shown in the figures can, unless explicitly stated otherwise, also be implemented as an indirect connection or coupling. Functional units can be implemented in particular as hardware, software, or a combination of hardware and software.

The exemplary embodiment of a vehicle 100 schematically illustrated in FIG. 1 has a seating arrangement 105 with five individual seats or seating positions 105a to 105e. Each of the seats 105a to 105e is suitable for accommodating one person as a passenger of the vehicle 100. The vehicle 100 further comprises a radar sensor 110, which is mounted inside the vehicle cabin on its ceiling and configured so that it can scan the seating arrangement 105, at least substantially, by means of radar beams. Accordingly, the seats 105a to 105e, in particular their seat surfaces, are located at least in each case predominantly within an observation field 110a that can be scanned by the radar sensor 110. In addition, the vehicle 100 comprises a system 115 for the automated detection of a seat occupancy state of the seating arrangement 105 as a function of a radar scan of at least sections of the seating arrangement 105 with respect to the observation field 110a, carried out by the radar sensor 110.

The system 115 comprises in particular a data processing unit 115a with at least one microprocessor and a memory 115b signal-connected to it, in which a computer program is stored, which is configured for carrying out the method described in the following with reference to FIG. 4, for the automated detection of a seat occupancy state of the seating arrangement 105. Furthermore, the sensor data generated by the radar sensor 110 during the radar scan or information already obtained from this by further processing, can be or is stored in the memory 115b.

The vehicle 100 shown in FIG. 2 corresponds to the vehicle from FIG. 1, but in this case a baby seat B with a baby lying therein is arranged on the front passenger seat 105b as an object to be detected as part of a seat occupancy check. In the further following discussion of FIGS. 3A to 5B, reference is made to the configuration from FIG. 2.

In the following, reference is now made to FIGS. 3A to 3C, which each illustrate a radar point cloud, wherein in the interests of clarity of representation each inherently three-dimensional radar point cloud has been reduced to two dimensions by projection of the positions of the radar points of the radar point cloud on a plane spanned by two of its dimensions.

FIG. 3A illustrates an exemplary single radar point cloud 300 as acquired within a single measurement frame, i.e. as a result of a radar scan of the seating arrangement 105 by the radar sensor 110 during a defined time interval (measurement period). The position of the individual radar points within the radar point cloud 300 can be represented by spatial coordinates, for example, Cartesian coordinates X and Y can be assigned to the plane of the drawing and thus to each individual point. In reality, if the dimension reduction is due to the drawing is disregarded, a third coordinate Z should be added for the third spatial dimension.

If not only the spatial positions of the locations where the radar beam is reflected from the scanned objects are acquired as coordinates during the radar scanning, but a Doppler shift is measured as well, then the individual radar points can be classified according to the magnitude of this Doppler shift, in particular into two different classes. The latter can be achieved, for example, by comparing the Doppler shift with a predefined shift threshold that corresponds to a certain shift velocity. Depending on the result of the comparison, those radar points 310, which according to the value of their associated Doppler shift have no velocity or a velocity of the object surface at the reflection point that is below the shift threshold, can be classified as “static” radar points (shown in FIGS. 3A-3C in each case with a filled black circle). Conversely, those radar points 315 which have a Doppler shift above the shift threshold can be classified as “dynamic” radar points 315 (shown in FIGS. 3A-3C with a black ring in each case).

The classification of the radar points 310 and 315 according to their Doppler shift is not mandatory, but it can be used, however, to process the radar point cloud 300, in particular in the context of a pre-processing carried out before its evaluation, in particular to filter it depending on the classification. For example, this filtering could be carried out in such a way that only dynamic radar points 315 are taken into account for the evaluation, for example, in order to detect only moving objects.

FIG. 3B shows an accumulated radar point cloud 305 which was generated by accumulating multiple individual radar point clouds, for example by accumulating six (i.e. N=6) individual radar point clouds from six, in particular consecutive, measurement frames. In the present example, the individual radar point cloud 300 from FIG. 3A is one of these radar point clouds combined by accumulation, so that their radar points 310 and 315 are also found in FIG. 3B. By comparing figures FIG. 3A and FIG. 3B it is easy to see that due to the accumulation the average radar point density in FIG. 3B is significantly higher than in FIG. 3A. In particular, it can also be seen that in the respective regions 320 marked by circles a particularly high radar point density prevails, which in particular includes both static radar points 110 and dynamic radar points 115. This indicates that an object is highly likely to be present (high radar point density) that is at least partially moving (high point density of dynamic radar points).

N=6 represents a particularly advantageous choice for N, because it covers both multiple periods of the periodic breathing process recognizable in FIG. 3B and the accumulation with respect to the number of the individual radar point clouds combined by accumulation is short enough to obtain all important data (such as the breathing pattern itself and the length of a breath) for the subsequent evaluation in the resulting accumulated radar point cloud 305.

FIG. 3C shows the same radar point cloud 305 as in FIG. 3B. In addition, however, cuboid (3D case) or in the present 2D representation, rectangular, selected spatial regions 325a to 325e are indicated here, which are spatially assigned to the respective position of the individual seats 105a to 105e. The definition of these spatial regions 325a to 325e can now be used to cluster the accumulated radar point cloud 305, wherein each radar point 310 or 315, as far as possible, is assigned to the spatial region 325a to 325e in which it lies. Any radar points not located in one of the spatial regions 325a to 325e may be subsequently disregarded. In particular, it can be seen that the regions 320 with particularly high radar point density are located in the area of the front passenger seat 105b, on which the baby seat with the baby B is located according to FIG. 2.

FIG. 4 shows a flow diagram illustrating an exemplary embodiment 400 of a method for automatically detecting a seat occupancy state of a seating arrangement. The method can in particular be embodied as a computer-implemented method. For this purpose, it can be stored in particular in the memory 115b of the system 115 as a computer program and be executable on the data processing unit 115a.

In the method 400, an initialization process 405 is first performed, by way of which initial values for various parameters of the method are set. In particular, a counter i for measurement frames and a counter j for generated accumulated radar point clouds can be co-initialized, for example with i=0 and j=0. Furthermore, a parameter N in particular can be initialized here, which specifies a number of individual radar point clouds corresponding to an appropriate number of different measurement frames (e.g. radar point cloud 300), which are to be combined into an accumulated radar point cloud (e.g. accumulated radar point cloud 305). In addition, a further parameter M can be initialized, which specifies as part of a rolling accumulation how many new measurement frames are added at the next rolling step, while a corresponding number of old measurement frames is excluded at the same time. In addition, a number L of measurement frames may be defined as a further parameter, which must have been included in total as part of the rolling accumulation, before an evaluation of the generated sequence of accumulated radar point clouds is carried out with regard to the detection of a seat occupancy state. In this example, the exemplary values N=6, M=1 and L=48 are set.

After the initialization process 405 is completed, another phase of method 400 begins, in which radar measurement data are received, in the present example from the radar sensor 110 of the vehicle 100, and are further processed to form one or more accumulated radar point clouds. For this purpose, in a process 410, the radar measurement data for a new measurement frame are first received from a temporal, in particular periodic, sequence of multiple measurement frames. At the same time, the counter i is incremented to indicate the reception of the radar measurement data of a new measurement frame. In a further process 415 it is then checked whether radar measurement data for N measurement frames have already been received. If this is not the case (415—no then), the process 410 is repeated until the radar measurement data for N measurement frames, which each represent a single radar point cloud measured at a time or in a time period corresponding to the respective measurement frames, have been received.

Then, in a further process 420, the N first individual radar point clouds 300 received are accumulated to form an accumulated radar point cloud 305. Optionally, filtering can be carried out to ensure that static radar points, i.e. radar points that have a Doppler-shift value lower than a predefined Doppler-shift threshold, are filtered out. The Doppler-shift threshold can also be initialized, optionally, in particular in the initialization process 405.

The accumulated radar point cloud 305 now present can then be clustered in a further process 425, in which each of its radar points is checked to determined whether the point is within one of the defined spatial regions 325a to 325e (see FIG. 3C) and if so, in which one. Thus, each one of all the points can be assigned either to one of the spatial regions 325a to 325e or to the other observation field. All radar points located within the same spatial region 325a to 325e are combined to form a cluster. As a result, each of the seats 105a to 105e is assigned a corresponding cluster of the accumulated radar point cloud 305. This forms the basis for the fact that for each seat 105a to 105e, an individual evaluation can subsequently be made as to whether or not the respective seat 105a to 105e is or was occupied during the by the N measurement frames on the basis of which the accumulated radar point cloud 305 was formed.

In order to facilitate the subsequent evaluation of the clustered accumulated radar point clouds 305, a corresponding characteristic value K(i) can be determined for each of the clusters in a process 430, wherein this characteristic value K(i) can be defined in particular as the number of radar points in the cluster. If no Doppler-shift value filtering has taken place, this can be a combined count of both the static and the dynamic radar points 310 and 315, respectively. However, if the static radar points 310 were previously filtered out, for example, in the process 420 as mentioned above, this would only involve a count of the dynamic radar points 315.

Since the subsequent evaluation is to be based on a curve of the characteristic value K(i) over a value range of counter i defined by the parameter L, a check is carried out in process 435 to determine whether a total of L measurement frames have already been processed. If this is not the case (435—no), the method returns to step 410 in order to receive another measurement frame and determine the further points of a new accumulated radar point cloud and its characteristic value. Otherwise (435—yes), the procedure can be continued to determine a seat occupancy state in a process 440, as will be explained below.

First, however, FIGS. 5A and 5B will be discussed, each illustrating an exemplary curve of the value of the characteristic value K(i) for the cluster formed for seat 105b or spatial region 325b in FIGS. 5A and 5B.

In FIG. 5A, for the purposes of a comparison with FIG. 5B, the number K(i) of the radar points to be counted per individual measurement frame i is shown without an accumulation taking place. The total number K(i) for the first L=48 measurement frames is shown here.

In contrast, in FIG. 5B according to the method 400, a corresponding illustration of a curve 505 of the characteristic value K(i) is shown, wherein the rolling accumulation took place over each N=6 measurement frames. The counter i corresponds here to an index of the first measurement frame taken into account as part of the accumulation. The accumulated number of radar points which results from an accumulation of the first N=6 measurement frames 1 to 6 is thus assigned to a counter value i=1 in the diagram of FIG. 5B. The accumulated number of radar points from the subsequent accumulation of the measurement frames 2 to 7 is then assigned to the value i=2, and so on.

According to the initialization of N=6 and M=1 selected in this example, six measurement frames or their associated individual radar point clouds 300 are thus accumulated and, during the transition from one accumulation to the next, the first measurement frame is removed from the next accumulation and replaced by a following measurement frame in the sequence of the measurement frames, which has not yet been taken into account. This is indicated in FIG. 5B by the square brackets in the lower left part of the image. The rolling accumulation proceeds until the number of measurement frames defined by the third parameter L has been processed in total, thus in the present example a total of L=48 measurement frames have been taken into account as part of the accumulation for the formation of the various accumulated radar point clouds.

When comparing the curves of K(i) from FIGS. 5A and 5B, it is easy to see that the curve of K(i) from FIG. 5B is smoothed compared to that of FIG. 5A. However, the characteristic periodic pattern, which may be caused in particular by a breathing action of the baby B on the seat 105b detected during the radar measurement, remains present due to the appropriate choice of N=6. However, the greater the value of N, the more likely is the risk that such patterns will be flattened or disappear as part of the smoothing, which means that N should be appropriately specified here with a view to preserving these patterns.

Now referring to FIG. 4 again, the evaluation of the characteristic value K(i) curve for the cluster for seat 105b can now take place (the same process can be carried out for the respective clusters for the other seats). In process 440, the characteristic value K(i) curve from FIG. 5B is provided to an evaluation model as an input variable. This can be, in particular, a model based on machine learning, such as an artificial neural network or a decision tree-based model. The training and, optionally, validation data used for the previous training can be structured in such a way that that they each contain curves of the characteristic value K(i) corresponding to the type shown in FIG. 5B for a plurality of different radar point clouds or clusters thereof, and for each curve of K(i) an assigned correct class of a classification of possible seat occupancy states. This allows the model to be trained and validated as part of a supervised learning procedure. In the simplest case, seat occupancy states indicate whether the seat is occupied or not. However, more advanced classifications are also conceivable, in which, in the case of the presence of an object, the respective class additionally specifies the type of object it is, for example, a moving or a stationary object, and in the case of a moving object in particular, whether it is a person (in principle identifiable in particular by means of a breathing pattern in the characteristic value K(i) curve).

As an alternative to a machine-learning model, a simple comparison algorithm in particular can also be used, in which, in the sense of a mathematical function, the curve of the characteristic value K(i) is used as an input variable and compared with one or more comparison thresholds in order to obtain a classification result. It is also conceivable that, in particular for detecting a respiratory frequency as the basis for carrying out the classification, a frequency analysis of K(i) is carried out, for example by means of a Fourier transformation.

If in the process 440 a seat occupancy state was determined based on the evaluation model for the seating arrangement 105, in particular for one or more of its seats 105a to 105e individually, this result can be output as corresponding information in process 445, for example, on a user interface of the vehicle or in the form of data for further processing by one or more other systems, in particular systems of the vehicle.

In this example, this information will be used in particular to check whether or not a belt warning signal should be issued, depending on the seat occupancy state of a particular seat 105a to 105e and the result of a test to determine whether or not a corresponding seatbelt for that seat has been fastened.

To do this, in process 450 it can be checked whether the seatbelt for the seat concerned (here, for example, for seat 105b) is fastened and in step 455 a functionality of the vehicle 100 is controlled depending on the information output in process 445 on the seat occupancy state and the status of the seatbelt determined in process 450. In particular, this can be carried out in such a way that in process 455 a signal source for outputting an in particular optical and/or acoustic seatbelt status signal is activated in order to signal to one or more other occupants of the vehicle, if necessary, that a seat is occupied but the seatbelt there is not fastened. The method then branches back to step 410 to start another loop pass.

While at least one exemplary embodiment has been described above, it has to be noted that there are a large number of variations in this respect. It is also to be noted here that the described exemplary embodiments constitute only non-limiting examples and they are not intended to limit the scope, applicability or configuration of the devices and methods described here. Instead, the above description will provide a person skilled in the art with an indication for the implementation of at least one exemplary embodiment, wherein it is understood that various changes in the means of functioning and the arrangement of the elements described in an exemplary embodiment can be made without departing here from the subject matter which is respectively defined in the appended claims or its legal equivalents.

### LIST OF REFERENCE SIGNS

B baby in baby seat
100 vehicle
105 seating arrangement
105a-e seats or seating positions
110 radar sensor
110a observation field of the radar sensor 110
115 system for automatically detecting a seat occupancy state
115a data processing unit
115b memory
300 (single) radar point cloud
305 accumulated radar point cloud
310 static radar points
315 dynamic radar points
320 regions of the accumulated radar point cloud 305 with high radar point density
325a-e spatial regions for cluster definition
400 method for automatically detecting a seat occupancy state
405-455 individual processes or method steps within the context of the method 400
500 curve of the characteristic value K(i) for a single radar point cloud
505 curve of the characteristic value K(i) for a cumulative radar point cloud

1. A method for automatically detecting a seat occupancy state of a seating arrangement having at least one seat, wherein the method comprises:
receiving or generating measurement data, which represents one assigned radar point cloud for each measurement of a sequence of a plurality of temporally consecutive measurement frames, so that the measurement data represents a sequence of radar point clouds corresponding to the sequence of measurement frames, wherein each radar point cloud of the sequence was or is obtained on the basis of a radar scan of a spatial region surrounding at least some sections of the seating arrangement, which takes place at a measurement time or during a measurement period assigned to the respective measurement frame;
accumulating a plurality of the radar point clouds of the sequence in order to obtain an accumulated radar point cloud containing radar points from each of the individual radar point clouds combined as part of the accumulating process;
determining a seat occupancy state of the seating arrangement on the basis of an evaluation model, which returns, as a function of the accumulated radar cloud, one of a plurality of predefined possible seat occupancy states of the seating arrangement as an evaluation result; and
outputting a piece of information defined according to the evaluation result.

2. The method as claimed in claim 1, wherein:
the accumulation of the plurality of radar point clouds of the sequence is carried out multiple times in order to obtain an accumulated radar point cloud, which contains radar points from each of the individual radar point clouds combined as part of the respective accumulation, wherein during each accumulation, only radar point clouds of an individual subset of the sequence assigned thereto are accumulated, so that at least two of the subsets are different; and
the seat occupancy state of the seating arrangement is determined as a function of at least two of the accumulated radar point clouds.

3. The method as claimed in claim 2, further comprising:
for each of the at least two accumulated radar point clouds taken into account in determining the seat occupancy state, determining the respective value of at least one defined characteristic value (K(i)) for characterizing radar point clouds;
wherein the evaluation model is or will be defined in such a way that, when determining the seat occupancy state of the seating arrangement, the evaluation result is determined as a function of the respective values of the at least one characteristic value (K(i)) for the at least two accumulated radar point clouds that are taken into account in determining the seat occupancy state.

4. The method as claimed in claim 3, wherein the subsets are selected on a rolling basis in order to form an ordered series of subsets, that a first of the subsets has a number N of consecutive point sets in the sequence, and each subsequent further subset emerges from the respective preceding subset by replacing the leading point sets of the preceding subset, in accordance with their order in the sequence M, in the following subset by the next M point sets in the sequence, where 0<M<N with N, M ∈ N applies.

5. The method as claimed in claim 4, wherein:
N is or will be selected such that 4<N<8; and/or
M is or will be selected such that M=1 or M=2.

6. The method as claimed in claim 4, wherein when determining the seat occupancy state of the seating arrangement, the evaluation result is determined as a function of the series of the respective values of the characteristic value (K(i)) for the subsets of the series corresponding to the series of subsets, for each characteristic value (K(i)).

7. The method as claimed in claim 5,
wherein for at least one of the characteristic values the series of their respective values is analyzed to determine whether a periodic curve of the characteristic value (K(i)) is detected therein, and
the evaluation result is determined according to the result of the analysis.

8. The method as claimed in claim 3, wherein the or one of the characteristic values is or will be defined by the number of radar points in the respective accumulated radar point cloud or a quantity dependent on that number.

9. The method as claimed in claim 1, wherein the sequence of the measurement frames is or will be defined such that the temporally consecutive measurement frames therein periodically follow one another at a frequency f with 6 fps≤f≤9 fps.

10. The method as claimed in claim 1, wherein the evaluation model comprises:
a trained machine learning model; and
data which at least represents an accumulated radar point cloud or values of one or more characteristic values defined for them, is provided as input data to the machine learning model in order to obtain the evaluation result as its output.

11. The method as claimed in claim 1, wherein,
the seating arrangement has a plurality of seats for which a seat occupancy state is to be determined individually or cumulatively as part of the method;
for each radar point cloud, the set of its radar points is sub-divided by means of clustering, as a function of the respective spatial position of the radar points in relation to the seats, into a plurality of clusters each containing a subset of the radar points, in order to individually assign to each of the seats one of the clusters located spatially closest to it;
the accumulation of radar point clouds of the sequence is carried out in clusters, wherein for each cluster, only the radar points belonging to said cluster of the respective radar point clouds to be accumulated are accumulated, in order to form a respective accumulated radar point cloud for each cluster; and
the determination of the seat occupancy state of the seating arrangement comprises:
an individual determination of a respective individual seat occupancy state for each of the seats as a function of the accumulated radar point cloud determined for the respective associated cluster, in order to obtain an evaluation result characterizing a seat occupancy state of the respective seat; and
the information to be output is defined according to the respective individual evaluation results for the different seats.

12. The method as claimed in claim 11, wherein each radar point cloud is segmented into multiple clusters, by each of the seats being assigned as a cluster a subset of the radar points of the respective radar point cloud depending on their respective position, such that the radar points of the cluster are located in a defined closed spatial region in the vicinity of the seat.

13. The method as claimed in claim 1, wherein:
the seating arrangement has a plurality of seats for which a seat occupancy state is to be determined individually or cumulatively as part of the method;
for each accumulated radar point cloud, the set of its respective radar points is sub-divided by means of clustering, as a function of the respective spatial position of the radar points in relation to the seats, into a plurality of clusters each containing a subset of the radar points, in order to individually assign to each of the seats one of the clusters located spatially closest to it; and
the determination of the seat occupancy state of the seating arrangement comprises:
an individual determination of a respective individual seat occupancy state for each of the seats as a function of the accumulated radar point cloud determined for the respective associated cluster, in order to obtain an evaluation result characterizing a seat occupancy state of the respective seat, and
the information to be output is defined according to the respective individual evaluation results for the different seats.

14. The method as claimed in claim 13, wherein each accumulated radar point cloud is segmented into multiple clusters, by each of the seats being assigned as a cluster a subset of the radar points of the respective accumulated radar point cloud depending on their respective position, such that the radar points of the cluster are located in a defined closed spatial region in the vicinity of the seat.

15. The method as claimed in claim 1, wherein the output of the information comprises activating a signal source as a function of the information to cause the signal source to output a defined signal depending on the activation.

16. The method as claimed in claim 15, wherein the signal source is activated as a function of the information so as output a signal if the information results from an evaluation result, according to which at least one seat of the seating arrangement is occupied and/or a selected predefined seat occupancy state is present.

17. The method as claimed in claim 16, further comprising:
detecting a seatbelt fastening state of at least one seat in the seating arrangement or receiving seatbelt information characteristic of the seatbelt fastening state;
wherein the signal source is activated as a function of the seatbelt information and the information from the evaluation result, in such a way as to output a seatbelt fastening warning signal if, according to the information, at least one seat of the seating arrangement is occupied and/or a selected predefined seat occupancy state is present and indicates seatbelt information that the associated seatbelt is not fastened.

18. The method as claimed in claim 1, wherein the individual radar points for each radar point cloud are represented by a position of the respective radar point in three-dimensional space and by at least one of the following parameters:
a Doppler-shift value of the radar signal at the relevant radar point; and
a signal-to-noise ratio value of the radar signal at the relevant radar point.

19. The method as claimed in claim 18, wherein:
the individual radar points of each radar point cloud are represented by a position of the respective radar point in three-dimensional space and by the Doppler-shift value of the radar signal for the respective radar point; and
the determination of the seat occupancy state of the seating arrangement on the basis of the evaluation model is carried out exclusively, or at least predominantly in a numerical sense, on the basis of such radar points, the Doppler-shift value of which is at or above a predefined non-zero shift threshold.

20. A system for automatically detecting a seat occupancy state of a seating arrangement having at least one seat, wherein the system comprises a data processing device which is configured to carry out the method according to claim 1 for detecting the seat occupancy state.

21. A non-transitory computer program or computer program product, comprising instructions which, when executed on the data processing device of the system according to claim 20, cause the system to carry out a method comprising:
receiving or generating measurement data, which represents one assigned radar point cloud for each measurement of a sequence of a plurality of temporally consecutive measurement frames, so that the measurement data represents a sequence of radar point clouds corresponding to the sequence of measurement frames, wherein each radar point cloud of the sequence was or is obtained on the basis of a radar scan of a spatial region surrounding at least some sections of the seating arrangement, which takes place at a measurement time or during a measurement period assigned to the respective measurement frame;
accumulating a plurality of the radar point clouds of the sequence in order to obtain an accumulated radar point cloud containing radar points from each of the individual radar point clouds combined as part of the accumulating process;
determining a seat occupancy state of the seating arrangement on the basis of an evaluation model, which returns, as a function of the accumulated radar cloud, one of a plurality of predefined possible seat occupancy states of the seating arrangement as an evaluation result; and
outputting a piece of information defined according to the evaluation result.

22. A vehicle, comprising:
a seating arrangement with at least one seat;
a radar sensor for radar scanning at least sections of the seating arrangement; and
a system according to claim 20 for the automated detection of a seat occupancy state of the seating arrangement as a function of a radar scan of at least sections of the seating arrangement carried out by the radar sensor.
